(19) United States
(12) Patent Application Publication
(10) Pub. No.: US 2007/0005213 A1
(43) Pub. Date: Jan. 4, 2007

(54) Backward control for automobiles using telematics and method thereof

(75) Inventors: Seong-Taeg Nou, Ichon-si (KR); Hyeon-Su Kim, Ichon-si (KR); Chang-Hwan Lim, Ichon-si (KR); Jung-Hyun Lim, Ichon-si (KR); Jun-Ho Lee, Ichon-si (KR)

Correspondence Address: STAAS & HALSEY LLP, SUITE 700, 1201 NEW YORK AVENUE, N.W., WASHINGTON, DC, 20005, US

(73) Assignee: Hyundai Autonet Co., Ltd., Ichon-si (KR)

(21) Appl. No.: 11/170,080

(22) Filed: Jun. 30, 2005

(51) Int. Cl. G06F 19/00

(52) U.S. Cl. 701/70; 701/301; 340/436

(57) ABSTRACT

Disclosed herein is a backward control system for an automobile using telematics. The system includes: a sensor unit to sense a backward speed, presence of a backward object, and the operating state of the brake pedal and the accelerator pedal of an automobile when backward-travelling; a telematics system unit to output a control signal, when a distance between the automobile and the object is within a pre-set range in response to the signal from the sensor unit, such that the backward-travelling is automatically interrupted to thereby prevent collision with the object; and a accelerator pedal control unit and a brake pedal control unit to automatically control the operation of the accelerator pedal and the brake pedal to thereby interrupt the backward-travelling in response to the control signal outputted from the telematics system unit.

### BACKGROUND OF THE INVENTION

1. Field of the Invention

The present invention relates to a technology for preventing an automobile from colliding with a backside object when backward-travelling. More specifically, the invention relates to a backward control system and method for automobiles using telematics, in which a brake pedal control unit, a accelerator pedal control unit and a back warning system are operatively connected to an automobile telematics system, and thus, when a distance to a backside object is within a preset distance range during back-travelling, the back-travelling of the automobile is automatically interrupted by the accelerator pedal and brake pedal control units, thereby preventing a collision accident with the object when backward-travelling.

2. Description of the Related Art

As is well-known in the art, while driving an automobile, a blind area, which cannot be viewed by a driver, is formed in the backside of the automobile.

Conventionally, in order to secure the view for the blind area, a sensor is provided in automobiles, and also a distance warning system, i.e., a back warning system operated from the sensor is mounted on the automobiles. Thus, when an automobile travels backwards and an object exists in the backside thereof, these warning systems are operated to thereby alert the driver of the present of the object.

In anther conventional technique, a camera is mounted on the rear side of an automobile, and then the picture taken by the camera is displayed on a monitor in the dashboard.

However, in the conventional back warning system, even though it is operated, it is very difficult to find out the correct position of an object and the correct distance to the object.

Furthermore, in case of the rear side camera, its function is limited to display a rearview through a monitor. Thus, in case where the rear view is not clear or an object abruptly approaches the rear side of the automobile, it is not easy to respond immediately to those situations. Although the conventional back warning system and rearview camera are installed in an automobile, a collision accident has been frequently occurred when the automobile travels backwards.

### SUMMARY OF THE INVENTION

Additional aspects and/or advantages of the invention will be set forth in part in the description which follows and, in part, will be apparent from the description, or may be learned by practice of the invention.

Therefore, the present invention has been made in view of the above problems occurring in the prior art, and it is an aspect of the present invention to provide a backward control system and method for automobiles using telematics, in which a brake pedal control unit, a accelerator pedal control unit and a back warning system are operatively connected to an automobile telematics system, and thus, when a distance to a backside object is within a preset distance range during back-travelling, the back-travelling of the automobile is automatically interrupted controlling the accelerator pedal and brake pedal control units, thereby preventing a collision accident with the object, and also solving the problems with the conventional techniques where an object abruptly approaches the rear side of an automobile.

According to an aspect of the present invention, there is provided a backward control system for an automobile using telematics. The system includes: a sensor unit to sense a backward speed, presence of a backward object, and the operating state of the brake pedal and the accelerator pedal of an automobile when backward-travelling; a telematics system unit to output a control signal, when a distance between the automobile and the object is within a pre-set range in response to the signal from the sensor unit, such that the backward-travelling is automatically interrupted to thereby prevent collision with the object; and a accelerator pedal control unit and a brake pedal control unit to automatically control the operation of the accelerator pedal and the brake pedal to thereby interrupt the backward-travelling in response to the control signal outputted from the telematics system unit.

According to an embodiment of the present invention, the sensor unit may include a first sensor to sense the speed of automobile when backward-travelling, a second sensor to detect a distance between the backward-travelling automobile and the object, a third sensor to sense the operation state of the accelerator pedal caused by a driver, and a fourth sensor to sense the operation state of the brake pedal caused by the driver.

According to an embodiment of the present invention, the telematics system unit may include: a distance setup unit to set up a approaching distance between the backward-travelling automobile and the object; a speed setup unit to set up a speed value with which the brake pedal is operated to stop the automobile; a memory unit to store information set-up through the distance setup unit and the speed setup unit; a signal receiver unit to receive a signal sensed from the sensor unit; a brake control unit to output a control signal to operate and control the accelerator pedal control unit and the brake pedal control unit based on the approaching distance and the speed value stored in the memory unit when the signal receiver unit receives the sensing signal from the sensor unit; and a signal output unit to output the control signal from the brake control unit to the accelerator pedal control unit and the brake pedal control unit.

According to an embodiment of the present invention, the telematics system unit may be provided with a rear view camera for photographing the rear side of the automobile in order for a driver to view the situation at the rear side of the automobile.

According to another aspect of the present invention, a backward control method for an automobile using telematics. The method includes: detecting a backside object, a backward-travelling speed, and an operating state of a accelerator pedal and a brake pedal caused by a driver when backward-travelling; calculating a distance between the object and the automobile; determining whether the distance between the automobile and the object is within the a preset approaching range, as the result of the calculation; automatically stopping the automobile by interrupting the power of the accelerator pedal through operation control of a accelerator pedal control unit if the accelerator pedal is operated when the distance between the automobile and the object is within the preset approaching range based on the determination; determining whether the backward-travelling speed due to the operation of the brake pedal approaches a preset interruption speed value if the brake pedal is operated when the distance between the automobile and the object is within the preset approaching range; automatically stopping the automobile by forcible controlling the operating of the brake pedal through a brake pedal control unit if the backward-travelling speed due to the operation of the brake pedal does not approach a preset interruption speed value based on the determination; and stopping the automobile from the continuous operation of the brake pedal by the driver if the backward-travelling speed due to the operation of the brake pedal approaches a preset interruption speed value based on the determination.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a backward control system for automobiles using telematics according to an embodiment of the present invention;

FIG. 2 illustrates the backward control system of the invention when mounted on an automobile; and

FIG. 3 is a flow chart explaining a backward control method for automobiles using telematics according to one embodiment of the invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

According to an embodiment of the invention will be hereafter described in detail, with reference to the accompanying drawings.

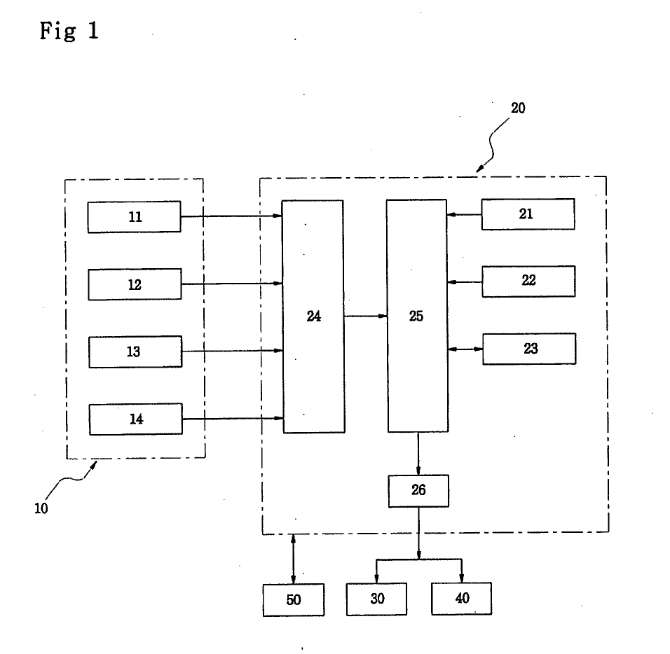

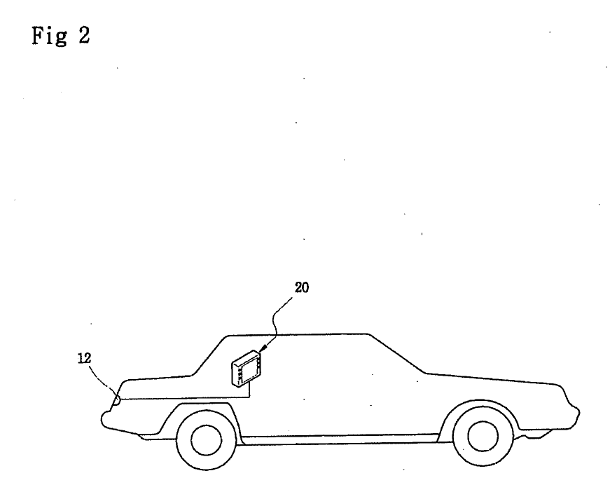

FIG. 1 is a block diagram illustrating a backward control system for automobiles using telematics according to one embodiment of the invention. FIG. 2 illustrates the backward control system of the invention when mounted on an automobile.

As illustrated in FIGS. 1 and 2, the backward control system of the invention includes: a sensor unit 10 to sense a backward speed, presence of a backward object, and the operating state of the brake pedal and the accelerator pedal of an automobile when backward-travelling; a telematics system unit 20 to output a control signal, when a distance between the automobile and the object is within a pre-set range in response to the signal from the sensor unit 10, such that the backward-travelling is automatically interrupted to thereby prevent collision with the object; and a accelerator pedal control unit 30 and a brake pedal control unit 40 to automatically control the operation of the accelerator pedal and the brake pedal to thereby interrupt the backward-travelling in response to the control signal outputted from the telematics system unit 20.

According to an aspect of the present invention, the sensor unit 10 includes a first sensor 11 to sense the speed of automobile when backward-travelling, a second sensor 12 to detect a distance between the backward-travelling automobile and the object, a third sensor 13 to sense the operation state of the accelerator pedal caused by a driver, and a fourth sensor 14 to sense the operation state of the brake pedal caused by the driver.

According to an embodiment of the present invention, the telematics system unit 20 includes a distance setup unit 21 to set up a approaching distance between the backward-travelling automobile and the object; a speed setup unit 22 to set up a speed value with which the brake pedal is operated to stop the automobile; a memory unit 23 to store information set-up through the distance setup unit 21 and the speed setup unit 22; a signal receiver unit 24 to receive a signal sensed from the sensor unit 10; a brake control unit 25 to output a control signal to operate and control the accelerator pedal control unit 30 and the brake pedal control unit 40 based on the approaching distance and the speed value stored in the memory unit 23 when the signal receiver unit 24 receives the sensing signal of the sensor unit 10; and a signal output unit 26 to output the control signal from the brake control unit 25 to the accelerator pedal control unit 30 and the brake pedal control unit 40.

According to another embodiment of the present invention, the telematics system unit 20 is provided with a rear view camera 50 to photograph the rear side of the automobile in order for the driver to view the situation at the rear side of the automobile.

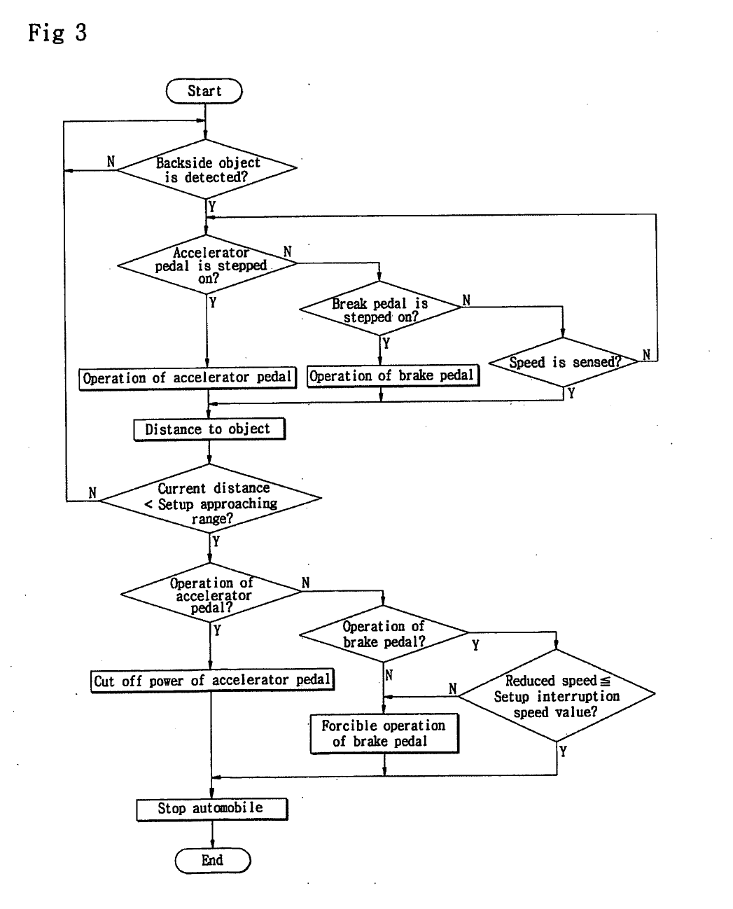

FIG. 3 is a flow chart explaining a backward control method for automobiles using telematics according to an embodiment of the present invention.

The backward control method of the invention includes: detecting a backside object, a backward-travelling speed, and an operating state of a accelerator pedal and a brake pedal caused by a driver when backward-travelling; calculating a distance between the object and the automobile; as the result of the calculation, determining whether the distance between the automobile and the object is within the a preset approaching range; automatically stopping the automobile by interrupting the power of the accelerator pedal through operation control of a accelerator pedal control unit 30 if the accelerator pedal is operated when the distance between the automobile and the object is within the preset approaching range, as the result of the determination; determining whether the backward-travelling speed due to the operation of the brake pedal approaches a preset interruption speed value if the brake pedal is operated when the distance between the automobile and the object is within the preset approaching range; as the result of the determination, automatically stopping the automobile by forcible controlling the operating of the brake pedal through a brake pedal control unit 40 if the backward-travelling speed due to the operation of the brake pedal does not approach a preset interruption speed value; and as the result of the determination, stopping the automobile from the continuous operation of the brake pedal by the driver if the backward-travelling speed due to the operation of the brake pedal approaches a preset interruption speed value.

The operation of one embodiment of the present invention having the above-described construction is explained below, referring to FIGS. 1 to 3.

First, in case where the driver backward-runs an automobile while alternately operating the accelerator pedal and the brake pedal, the first sensor 11 of the sensor unit 10 detects the backward-travelling speed, which is outputted to the telematics system unit 20.

In addition, the second sensor 12 of the sensor unit 10, which is mounted on the rear side of the automobile, senses the presence of an object at the back side of the automobile and outputs the sensed information to the telematics system unit 20. The third and fourth sensors 13 and 14 in the sensor unit 10 sense the operation state of the accelerator pedal and the brake pedal and output the sensed information to the telematics system unit 20.

Furthermore, the signal receiver unit 24 included in the telematics system unit 20 receives signals from the sensor unit 10, i.e., the first to fourth sensors 11, 12, 13 and 14, and then outputs the signals to the brake control unit 25.

The brake control unit 25 calculates the distance between the backward-travelling automobile and the backside object, based on the sensed information from each sensor 11 to 14, and, as the result of the calculation, determines whether the distance between the automobile and the object is within the preset approaching range.

That is, the telematics system unit 20 includes a distance setup unit 21 to establish an approaching range between an automobile and an object when backward-travelling, and a speed setup unit 22 to establish an interruption speed value at the time of stopping the automobile by an operation of the brake pedal. The approaching range and the interruption speed value predetermined through the distance setup unit 21 and the speed setup unit 22 are stored in the memory unit 23.

The brake control unit 25 calculates a distance between the automobile and the object, based on the sensed signal form each sensor 11 to 14, and thereafter, by retrieving the memory unit 23, determines whether the distance between the automobile and the object is within the predetermined approaching range.

At this time, as the result of the above determination, when the distance between the automobile and the object is within the preset approaching range, the brake control unit 25 is configured such that it determines, based on the sensed signals from the third and fourth sensors 13 and 14, whether the accelerator pedal or the brake pedal is operated by the driver.

Accordingly, if the accelerator pedal is operated by the driver, the brake control unit 25 outputs a control signal through the signal output unit 26 to the accelerator pedal control unit 30 so as to control the operation of the accelerator pedal.

Then, when the accelerator pedal is operated by the driver, the accelerator pedal control unit 30 automatically interrupts the power transmission to the accelerator pedal to thereby stop the back-travelling automobile, thus preventing a collision accident, which may be occurred when the distance between the automobile and the object is within the predetermined approaching range.

On the other hand, when the distance between the automobile and the object is within the predetermined approaching range and if the brake pedal is operated, the brake control unit 25 determines whether the backward-travelling speed due to the operation of the brake pedal approaches the predetermined interruption speed value.

That is, while the brake pedal is operated by the driver, the brake control unit 25 compares the automobile speed information sensed from the first sensor 11 with the predetermined interruption speed value stored in the memory unit 23.

As the result of the comparison, in case where the backward-travelling speed due to the operation of the brake pedal does not approach the predetermined interruption speed value, the brake control unit 25 outputs a control signal through the signal output unit 26 to the brake pedal control unit 40 so as to more forcibly control the operation of the brake pedal.

Then, the brake pedal control unit 40 strengthens forcibly the control of the brake pedal such that the automobile can be automatically stopped, regardless of the operating intensity through the driver. Accordingly, a collision accident can be prevented, which may be occurred when the distance between the automobile and the object comes within the predetermined approaching range.

In addition, as the result of the above comparison, when the backward-travelling speed by the operation of the brake pedal approaches the predetermined interruption speed value, the brake control unit 25 does not forcibly control the operating intensity of brake pedal through the bake pedal control unit 40. Thus, the automobile can be stopped through the continuous operation of the brake pedal, which is operated by the driver.

In this way, according to an aspect of the present invention, when the distance between the backside object and the automobile comes within the approaching range preset by the distance setup unit 21, and if the speed of the automobile is reduced a driver's operation of the brake pedal so as to approach the interruption speed value predetermined by the speed setup unit 22, a collision accident between the automobile and the object can be automatically prevent.

When the distance between the backside object and the automobile becomes close to the approaching range predetermined by the distance setup unit 21, and if the accelerator pedal is operated by the driver, or even by the driver's operation of the brake pedal, the backward-travelling speed is not reduced so as to become close to the interruption speed value predetermined by the speed setup unit 22, the accelerator pedal and the brake pedal are forcibly controlled through the accelerator pedal and brake control units 30 and 40 to thereby automatically stop the automobile, thus preventing a collision accident between the automobile and the object.

On the other hand, as illustrated in FIG. 1, the rear view camera 50 is connected to the telematics system unit 20. Thus, additionally, through a monitor (not shown) of the telematics system unit 20, the driver can view the backside situation photographed by the rear view camera 50.

As described above, according to the backward control system and method for automobiles using telematics, a brake pedal control unit, an accelerator pedal control unit and a back warning system are operatively connected to an automobile telematics system. Thus, when a distance to a backside object is within a predetermined distance range during back-travelling, the back-travelling of the automobile is automatically interrupted by the accelerator pedal and brake pedal control units, thereby preventing a collision accident with the object when backward-travelling, and also and also solving the problems with the conventional techniques where an object abruptly approaches the rear side of an automobile.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A backward control system for an automobile using telematics, the system comprising:
a sensor unit to sense a backward speed, presence of a backward object, and the operating state of the brake pedal and the accelerator pedal of an automobile when backward-travelling;
a telematics system unit to output a control signal, when a distance between the automobile and the object is within a predetermined range in response to the signal from the sensor unit, such that the backward-travelling is automatically interrupted to thereby prevent collision with the object; and
an accelerator pedal control unit and a brake pedal control unit for automatically controlling the operation of the accelerator pedal and the brake pedal to thereby interrupt the backward-travelling in response to the control signal outputted from the telematics system unit.

2. The system according to claim 1, wherein the sensor unit comprises a first sensor to sense the speed of automobile when backward-travelling, a second sensor to detect a distance between the backward-travelling automobile and the object, a third sensor to sense the operation state of the accelerator pedal caused by a driver, and a fourth sensor to sense the operation state of the brake pedal caused by the driver.

3. The system according to claim 1, wherein the telematics system unit comprises:
a distance setup unit for setting up an approaching distance between the backward-travelling automobile and the object;
a speed setup unit to set up a speed value with which the brake pedal is operated to stop the automobile;
a memory unit to store information set-up through the distance setup unit and the speed setup unit;
a signal receiver unit to receive a signal sensed from the sensor unit;
a brake control unit to output a control signal to operate and control the accelerator pedal control unit and the brake pedal control unit according to the approaching distance and the speed value stored in the memory unit when the signal receiver unit receives the sensing signal of the sensor unit; and
a signal output unit to output the control signal from the brake control unit to the accelerator pedal control unit and the brake pedal control unit.

4. The system according to claim 1, wherein the telematics system unit further comprises a rear view camera to photograph the rear side of the automobile.

5. A backward control method for an automobile using telematics, the method comprising:
detecting a backside object, a backward-travelling speed, and an operating state of a accelerator pedal and a brake pedal caused by a driver when backward-travelling;
calculating a distance between the object and the automobile;
determining whether the distance between the automobile and the object is within a predetermined approaching range, as the result of the calculation; and
stopping the automobile by interrupting the power of the accelerator pedal through operation control of a accelerator pedal control unit if the accelerator pedal is operated when the distance between the automobile and the object is within the predetermined approaching range, as the result of the determination.

6. The method of claim 5, further comprising:
determining whether the backward-travelling speed due to the operation of the brake pedal approaches a predetermined interruption speed value if the brake pedal is operated when the distance between the automobile and the object is within the predetermined approaching range;
stopping the automobile by forcible controlling the operating of the brake pedal through a brake pedal control unit if the backward-travelling speed due to the operation of the brake pedal does not approach a preset interruption speed value based upon the determination; and
stopping the automobile from the continuous operation of the brake pedal by the driver if the backward-travelling speed due to the operation of the brake pedal approaches a predetermined interruption speed value.
